(19) United States
(12) Patent Application Publication
(10) Pub. No.: US 2008/0098951 A1
(43) Pub. Date: May 1, 2008

(54) Moveable counterbalanced stand alone flag pole

(76) Inventor: Nancy Sullivan, Washougal, WA (US)

Correspondence Address: KURT M. RYLANDER;RYLANDER & ASSOCIATES PC, 406 West 12th Street, Vancouver, WA, 98660, US

(21) Appl. No.: 11/586,984

(22) Filed: Oct. 25, 2006

(51) Int. Cl. G09F 17/00

(52) U.S. Cl. 116/173

(57) ABSTRACT

A moveable counterbalanced stand alone flag pole providing transportability and an increase of flag display locations includes a counterbalanced pole assembly having a lower portion, a mid-portion and an upper portion, such that a flag attached to the upper portion can freely wave, a ground tip on the end of the lower portion allowing the lower portion to be removably secured, and a washer in which the lower portion of the pole assembly fits whereby the pole assembly can rotate while the ground tip remains stationary.

### FIELD OF THE INVENTION

This invention relates generally to the field of flag poles, specifically moveable, transportable flag poles.

### BACKGROUND

A moveable counterbalanced stand alone flag pole is provided to display a flag. Flags are sold with either sleeves or openings, such as grommets, to permit the user to hang the flag from a flag pole. Flag poles permit the user to hang a flag on buildings, high up or away from objects that could interfere with the flag's waving. An existing problem for flag owners occurs when the flag owner wishes to transport the flag pole in order to display the flag in different locations or to display a flag in a movable manner, so as to maximize views of the flag as well as flag flapping. This problem is magnified at a camping or recreational vehicle site, where a user may wish to display a flag temporarily and easily remove the flag and pole with minimal impact on the surrounding area.

Previous options for displaying flags include stationary and often heavy poles or posts, and intricate pulley systems on poles. The process of changing a flag display location required either installation of an entirely new flag pole or the removal and relocation of an existing flag pole which was usually buried deep into the ground and/or fixed with concrete, requiring extensive time and labor as well as leaving a large hole in the former location. Furthermore, the user could not display the flag in a manner which allowed the entire flag to rotate and thus wave because previous options for display were rigid, stationary poles.

Presently known art attempts to address this problem, but has not completely solved the problem. The following represents a list of known related art:

| Reference: | Inventor(s): | Issue/Publication Date: |
|---|---|---|
| U.S. Pub. 2006/0042138 | Lavelle | Mar. 2, 2006 |
| U.S. Pub. 2004/0169121 | Winn | September 2004 |
| U.S. Pub. 2002/0104243 | Barber | Aug. 8, 2002 |
| U.S. Pat. No. 6,976,447 | Spiegel | Dec. 20, 2005 |
| U.S. Pat. No. 6,938,871 | Carlson | Sep. 6, 2005 |
| U.S. Pat. No. 6,668,750 | Walz et al. | Dec. 30, 2003 |
| U.S. Pat. No. 5,806,903 | George | Sep. 15, 1998 |
| U.S. Pat. No. 5,291,849 | Zeitler | Mar. 8, 1994 |
| U.S. Pat. No. 4,402,166 | Wortham, Jr. | Sep. 6, 1983 |
| U.S. Pat. No. 4,332,210 | Lambert | Jun. 1, 1982 |
| U.S. Pat. No. 3,941,083 | Morse et al. | Mar. 2, 1976 |
| U.S. Pat. No. 3,182,936 | Murdock | May 11, 1965 |
| U.S. Pat. No. 3,158,132 | Guthrie | Nov. 24, 1964 |
| U.S. Pat. No. 2,894,480 | Stephenson | Jul. 14, 1959 |
| U.S. Pat. No. 1,855,824 | Crichton | Apr. 26, 1932 |
| U.S. Pat. No. 1,613,979 | Bolander | Jan. 11, 1927 |
| U.S. Pat. No. 1,470,320 | Bolander | Oct. 9, 1923 |
| U.S. Pat. No. 1,295,274 | Crichton | Feb. 25, 1919 |
| U.S. Des. Pat. D 492,813 | Meoli | Jul. 6, 2004 |

The teachings of each of the above-listed citations (which does not itself incorporate essential material by reference) are herein incorporated by reference. None of the above inventions and patents, taken either singularly or in combination, is seen to describe the instant invention as claimed.

### SUMMARY AND ADVANTAGES

A moveable counterbalanced stand alone flag pole providing transportability and an increase of flag display locations includes a counterbalanced pole assembly having a lower portion, a mid-portion and an upper portion, such that a flag attached to the upper portion can freely wave, a ground tip on the end of the lower portion allowing the lower portion to be removably secured, and a washer in which the lower portion of the pole assembly fits whereby the pole assembly can rotate while the ground tip remains stationary.

The moveable counterbalanced stand alone flag pole of the present invention presents numerous advantages, including: (1) transportability; (2) ease in set-up and deconstruction of flag pole; (3) ease in attaching and interchanging flags; and (4) allowing the flag to rotate thereby increasing waving of the flag and display angles.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a detailed embodiment of the present invention.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

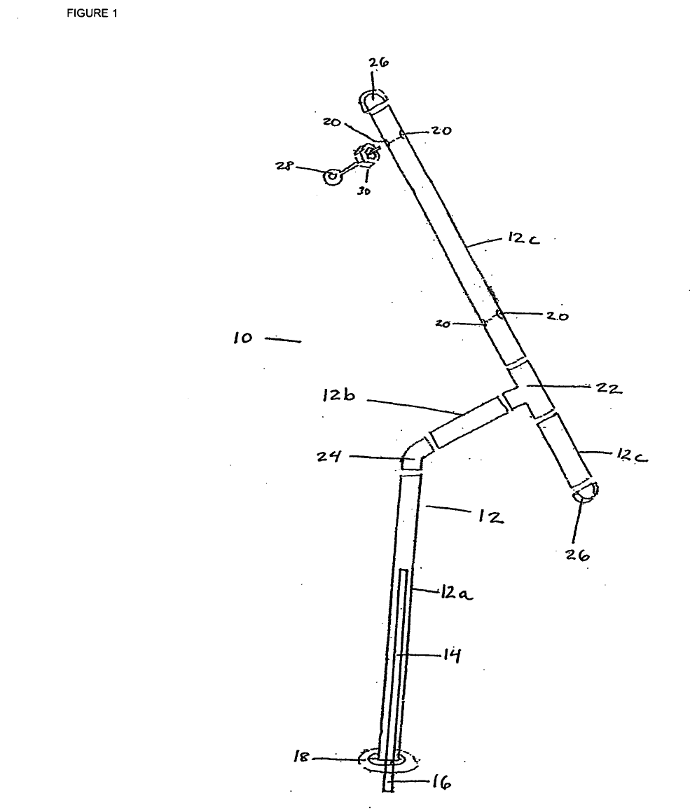

As shown in FIGS. 1, a moveable counterbalanced stand alone flag pole 10 is provided to allow a user to easily construct and deconstruct a portable but sturdy flag pole. A moveable counterbalanced stand alone flag pole 10 includes a counterbalanced pole assembly 12 having a lower portion 12a, a mid-portion 12b and an upper portion 12c, such that a flag attached to the upper portion 12c can freely wave, a ground tip 16 on the end of the lower portion 12a allowing the lower portion 12a to be removably secured, and a washer 18 in which the lower portion 12a of the pole assembly 12 fits whereby the pole assembly 12 can rotate while the ground tip 16 remains stationary.

The pole assembly 12 has three parts including a lower portion 12a, mid-portion 12b, and an upper portion 12c. It is preferable in this embodiment that the top of the lower portion 12a is bent at a forty-five degree angle so that when the mid-portion 12b is attached to the lower portion 12a, the mid-portion 12b is at a one hundred and thirty-five degree angle to the lower portion 12a. The mid-portion 12b and the upper portion 12c attach preferably at a ninety degree angle to one another at a point below the midpoint of the upper portion 12c, in this embodiment. The pole assembly 12 parts can be removably connected via fasteners such as: threaded joints, sockets, adhesives, tape, hook and loop fasteners, clips, hinges, wire, rope, snaps, buttons, bolts, and screws. For example, in one embodiment, a socket is provided at the bottom of the mid-portion 12b into which the lower portion 12a can be inserted and securely fit while another socket is located at a point, preferably ⅘ down from the top of the upper portion 12c, on the upper portion 12c into which the mid-portion 12b may be inserted and securely fit.

A rebar 14 can be provided extending into the lower portion 12a of the pole assembly 12 providing support; a ground tip 16 on the rebar 14 allowing the rebar 14 to be secured; and a washer 18 on which the lower portion 12a of the pole assembly 12 rests whereby the pole assembly 12 can rotate while the rebar 14 remains stationary; the user can removably attach a flag to the pole assembly 12. In this embodiment, it is preferable that the lower portion 12a is hollow, allowing the rebar 14 to fit inside the lower portion 12a and provide support to the pole assembly 12.

In the preferred embodiment, as shown in FIG. 1, a moveable counterbalanced stand alone flag pole 10 includes a pole assembly 12 having a lower portion 12a, a mid-portion 12b and an upper portion 12c, such that a flag attached to the upper portion 12c can freely wave, a rebar 14 extending into the lower portion 12a of the pole assembly 12 providing support, a ground tip 16 on the rebar 14 allowing the rebar 14 to be secured, a washer 18 on which the lower portion 12a of the pole assembly 12 rests whereby the pole assembly 12 can rotate while the rebar 14 remains stationary, an aperture 20 on the upper portion 12c, allowing the user to removably attach a flag to the upper portion 12c, a “T”-type connector 22 securing the mid-portion 12b to the upper portion 12c; an end cap 26 on the upper portion 12c; an eye bolt 28 fixed to the aperture 20 wherein a flag can be attached; and an angled connector 24 securing the lower portion 12a to the mid-portion 12b. In this embodiment, it is preferable that the lower portion 12a is hollow, allowing the rebar 14 to fit inside the lower portion 12a and provide support to the pole assembly 12.

The pole assembly 12 can also include and use fasteners including: threaded joints, sockets, adhesives, tape, hook and loop fasteners, clips, hinges, wire, rope, snaps, buttons, bolts, and screws to attach the lower portion 12a to the mid-portion 12b and the mid-portion 12b to the upper portion 12c.

The pole assembly 12 may be constructed of another type of plastic, wood, bamboo, metal, fiberglass, or a similar material that is rigid enough to stand upright once placed into the ground or a stand. The pole assembly 12 is preferably constructed of hollow PVC pipes, which are lightweight and sturdy. In the preferred embodiment, the lower portion 12a is 4 feet in length (1.219 m), the mid-portion 12b is 1 foot in length (0.305 m), and the upper portion 12c is 5 feet in length (1.524 m). Preferably, the pole assembly 12 is 1 inch (2.54 cm) in diameter. To support the moveable, counterbalanced stand-alone flag pole 10, a stand may be provided having an opening or socket in which to secure the pole assembly 12. One of ordinary skill in the art would realize that a stand could have a base or attaching mechanism securing the stand to a rigid object in order to support the pole assembly 12.

The rebar 14 may be constructed of plastic, wood, bamboo, metal, fiberglass, or a similar material that is rigid enough to stand upright once placed into the ground or a stand. The rebar 14 is preferably a metal rod, 4 feet in length (1.219 m), such that 3 feet (0.914 m) of the rebar 14 are inside the lower portion 12a, which is preferably hollow in this embodiment, and 1 foot (0.305 m) of the rebar 14 is in the ground or a stand. In the preferred embodiment, the rebar 14 is ⅝ an inch (1.588 cm) in diameter. To support the moveable, counterbalanced stand-alone flag pole 10, a stand may be provided having an opening or socket in which to secure the pole assembly 12. One of ordinary skill in the art would realize that a stand could have a base or attaching mechanism securing the stand to a rigid object in order to support the pole assembly 12.

Preferably, as shown in FIG. 1, the pole assembly 12 has six parts including a lower portion 12a, mid-portion 12b, an upper portion 12c divided into two parts, a “T”-type connector 22 securing said mid-portion 12b to said upper portion 12c of the pole assembly 12, and an angled connector 24 securing the lower portion 12a to the mid-portion 12b. The lower portion 12a is preferably hollow, allowing the rebar 14 to extend freely up into the lower portion 12a. The “T”-type connector 22 has at least three openings, preferably two are planar to one another and the third is perpendicular to the first two such that the connector 22 has the appearance of a “T” as seen in FIG. 1, and causing the upper portion 12c to be perpendicular to the mid-portion 12b when each portion 12b, 12c is attached to the “T”-type connector 22. The “T”-type connector 22 is located past the midpoint of the upper portion 12c, preferably ⅘ down from the top of the upper portion 12c. The “T”-type connector 22 is preferably larger in diameter than the mid-portion 12b and the upper portion 12c so that the mid-portion 12b and the upper portion 12c fit snugly inside the “T”-type connector's 22 openings. In another embodiment, the “T”-type connector 22 is smaller in diameter than the mid-portion 12b and the upper portion 12c so that the “T”-type connector 22 fits snugly inside the mid-portion 12b and the upper portion 12c.

The angled connector 24 preferably forms a forty-five degree angle so that, when in place, the angled connector 24 is fixed to the lower portion 12a and the mid-portion 12b is attached at the other end of the angled connector 24; consequently, the mid-portion 12b is at a one hundred and thirty-five degree angle to the lower portion 12a. The angled connector 24 is preferably larger in diameter than the lower portion 12a and the mid-portion 12b so that the lower portion 12a and the mid-portion 12b fit snugly inside the angled connector's 24 openings. In another embodiment, the angled connector 24 is smaller in diameter than the lower portion 12a and the mid-portion 12b so that the angled connector 24 fits snugly inside the lower portion 12a and the mid-portion 12b.

An aperture 20 may be used to fix the flag to the upper portion 12c. In the preferred embodiment, the upper portion 12c has at least four apertures 20. The apertures 20 are preferably in sets of two, such that each aperture 20 is opposite its paired aperture 20 on the upper portion 12c, thereby forming a hole through the upper portion 12c in which a flag can be secured. For example, it is preferable, as depicted in FIG. 1, that the moveable counterbalanced stand alone flag pole 10 further includes an eye bolt 28 fixed to an aperture 20 wherein a flag can be attached.

The end cap 26 fits over an end of the upper portion 12c to prevent water, grass, leaves, dirt and other elements from entering the upper portion 12c when the upper portion 12c is hollow. Additionally, the end cap 26 serves to secure the flag, when a flag is secured by its sleeve. The end cap 26 may be fixed to the upper portion via threaded joints, snap fits, clips, hinges, hook and fastener systems, and adhesives. In the preferred embodiment, as depicted in FIG. 1, the moveable counterbalanced stand alone flag pole 10 further includes an end cap 26, preferably two end caps 26, one on each end of the upper portion 12c of the pole assembly 12.

In use, the moveable counterbalanced stand alone flag pole 10 is assembled by the user connecting the portions of the pole assembly 12 such that the lower portion 12a is removably connected to the mid-portion 12b and the mid-portion 12b is removably connected to the upper portion 12c. When a “T”-type connector 22 is used, the user connects the mid-portion 12b to the “T”-type connector 22 and the upper portion 12c is divided into two parts, each of which connects to the two opposing ends of the “T”-type connector 22 such that upon assembly, the upper portion 12c is perpendicular to the mid-portion 12b. When an angled connector 24 is used, the user connects the lower portion 12a to the angled connector 24 and the mid-portion 12b to the angled connector 24 such that upon assembly the mid-portion 12b is at an obtuse angle to the lower portion 24a.

Once the pole assembly 12 is constructed, the user places the washer 18 over the bottom of the lower portion 12a so that the washer 18 rests at the bottom of the lower portion 12a upon the ground, soft surface or stand in which the pole assembly 12 is to be secured. Next, the user places the ground tip 16 of into the ground, soft surface or a stand which allows the pole assembly 12 to remain upright, preferably perpendicular to the ground, soft surface or stand.

When a rebar 14 is used, the user places the rebar 14 inside the lower portion 12a of the pole assembly 12, thereby providing additional support, and secures the ground tip 16 of the rebar 14 into the ground, soft surface or a stand which allows the pole assembly 12 to remain upright, preferably perpendicular to the ground, soft surface or stand. Once the rebar 14 is secured, the user can place the washer 18 over the rebar 14 so that the washer 18 slides down the rebar 14 and rests upon the ground, soft surface or stand in which the rebar 14 is secured. The user then places the pole assembly 12 over the rebar 14 thereby securing the pole assembly 12 upright, preferably perpendicular to the ground, soft surface or a stand in which the rebar 14 is secured. Alternatively, the user may choose to secure the rebar 14 and the lower portion 12a of the pole assembly 12 and then complete construction of the pole assembly 12. If the flag has openings, such as grommets, the fastener may be attached to the flag via the flag opening. The user can also attach a flag to the upper portion 12c of the pole assembly 12 by sliding the flag over the end of the upper portion 12c if the flag has a sleeve for fastening onto flag poles. The flag can be secured to the upper portion 12c via fasteners such as hooks, clips, hinges, tie wraps, string, wire, buttons, flag snaps, ropes, screws, bolts, halyards, adhesives, tape, a hook and loop fastening system and tabs.

If the upper portion 12c has an aperture 20, then the user can attach a flag to the upper portion 12c of the pole assembly 12 via the aperture 20, fasteners and/or the flag's grommets or openings. As shown in FIG. 1, an eyebolt 28 and nut 30 may be used as fasteners, allowing the flag to be attached to the eyebolt 28 via the flag's opening which is smaller than the eye of the eyebolt 28 or via additional fasteners securing the flag to the eyebolt 28, such as rope through the flag's opening and secured to the eyebolt 28. When used, the eyebolt 28 is placed through the aperture 20, passes out another aperture 20 on the opposite side of the upper portion 12c, and is then secured with a nut 30.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A moveable counterbalanced stand alone flag pole, comprising:
A counterbalanced pole assembly having a lower portion, a mid-portion and an upper portion, such that a flag attached to said upper portion can freely wave;
a ground tip on said lower portion's end allowing said lower portion to be removably secured; and
a washer in which said lower portion of said pole assembly fits whereby said pole assembly can rotate while said ground tip remains stationary.

2. A moveable counterbalanced stand alone flag pole, further comprising a rebar extending into said lower portion of said pole assembly providing support, wherein the ground tip fits on the end of said rebar allowing said rebar to be removably secured, and wherein said rebar fits in said washer whereby said pole assembly can rotate while said rebar remains stationary.

3. The moveable counterbalanced stand alone flag pole of claim 1 or 2, further comprising a “T”-type connector securing said mid-portion to said upper portion of said pole assembly.

4. The moveable counterbalanced stand alone flag pole of claim 1 or 2, further comprising an angled connector securing said lower portion to said mid-portion of said pole assembly.

5. The moveable counterbalanced stand alone flag pole of claim 1 or 2, further comprising an aperture on said upper portion of said pole allowing the user to removably attach a flag to said pole.

6. The moveable counterbalanced stand alone flag pole of claim 5, further comprising an eye bolt fixed to said aperture wherein a flag can be attached.

7. The moveable counterbalanced stand alone flag pole of claim 1 or 2, further comprising an end cap on said upper portion's end whereby said upper portion's ends are sealed.

8. The moveable counterbalanced stand alone flag pole of claim 1 or 2, further comprising a threaded joint on said pole assembly removably attaching said lower portion to said mid-portion or said mid-portion to said upper portion.

9. A moveable counterbalanced stand alone flag pole, comprising:
a counterbalanced pole assembly having a lower portion, a mid-portion and an upper portion, such that a flag attached to said upper portion can freely wave;
means for removably attaching said lower portion to said mid-portion;
means for removably attaching said mid-portion to said upper portion;
a rebar extending into said lower portion of said pole assembly providing support;
a ground tip on said rebar allowing said rebar to be removably secured;
means for permitting rotation of said pole assembly while enabling said rebar to remain stationary; and
means for removably attaching a flag to said upper portion of said pole assembly.

10. The moveable counterbalanced stand alone flag pole of claim 9, further comprising a “T”-type connector securing said mid-portion to said upper portion of said pole assembly.

11. The moveable counterbalanced stand alone flag pole of claim 9 or 10, further comprising an angled connector securing said lower portion to said mid-portion of said pole assembly.

12. The moveable counterbalanced stand alone flag pole of claim 9 or 10, further comprising an end cap on said upper portion of said pole assembly.

13. A moveable counterbalanced stand alone flag pole, comprising:
a counterbalanced pole assembly having a lower portion, a mid-portion and an upper portion, such that a flag attached to said upper portion can freely wave;
a rebar extending into said lower portion of said pole assembly providing support;
a ground tip on said rebar allowing said rebar to be secured;
a washer on which said lower portion of said pole assembly rests whereby said pole assembly can rotate while said rebar remains stationary;
an aperture on said upper portion of said pole allowing the user to removably attach a flag to said pole;
a “T”-type connector securing said mid-portion and said upper portion of said pole assembly;
an end cap on said upper portion of said pole assembly;
an eye bolt fixed to said aperture wherein a flag can be attached.

14. The moveable counterbalanced stand alone flag pole of claim 13, further comprising a threaded joint on said pole assembly removably attaching said lower portion to said mid-portion and said mid-portion to said upper portion.
